(19) United States
(12) Patent Application Publication
(10) Pub. No.: US 2004/0143696 A1
(43) Pub. Date: Jul. 22, 2004

(54) Data storage system for fast booting of computer

(76) Inventor: Francis Hsieh, Keelung (TW)

Correspondence Address: Alan D. Kamrath, NIKOLAI & MERSEREAU, P.A., 820 International Centre, 900 Second Avenue South, Minneapolis, MN, 55402-3325, US

(21) Appl. No.: 10/347,756

(22) Filed: Jan. 21, 2003

(51) Int. Cl. G06F 12/00

(52) U.S. Cl. 711/5

(57) ABSTRACT

A storage unit made of fast and slow storage medium is implemented to shorten computer boot time significantly. The unit is composed of fast storage medium such as random access memory (RAM) and slow storage medium such as FLASH, SRAM, Battery Powered RAM, ROM and CD-ROM etc. A data storage medium controller is implemented to move data between second data storage medium and slow storage medium in a way that is transparent to the system bus so that data moving can happen in parallel to computer initialization. This architecture allows computer to boot from a faster media without having to wait for data to be moved from slower media and hence making computer boot faster.

### BACKGROUND OF INVENTION

1. Field of Invention

The present invention relates to a data storage system for a computer and, more particularly, to a data storage system for fast booting of a computer and, more particularly, to a combination of a first data storage medium for storage of data in an economic and secure manner with a second data storage medium for receiving data from the first data for fast booting of a computer. For example, the first data storage medium may be an erasable and programmable non-volatile memory module connected to a computer host platform through a bus. The bus may be an IDE bus, USB bus, ISA bus, PCI bus, system RAM bus or any other appropriate bus. For example, the second data storage medium may be a RAM module.

2. Related Prior Art

Erasable and programmable non-volatile memories, hereinafter referred to as “flash memories” or “flash devices,” are known in the art for storage of data. Flash devices include electrically erasable and programmable read-only memories (“EEPROM”). An EEPROM consists of flash-type, floating-gate transistors, and is similar to an EPROM in function and performance except for allowing an in-circuit, programmable operation to erase pages of the memory. An example of such a flash device is given in U.S. Pat. No. 5,799,168, incorporated for reference as if fully set forth herein.

There is a significant trend to employ open architecture to develop appliances and embedded devices. Compared with proprietary architecture, open architecture enjoys a great availability of components in hardware and software from the open architecture society. It is easier to kick off a new design in open architecture than in proprietary architecture. Another advantage of open architecture is the availability of experienced engineer resource in the open architecture society.

In developing appliances and embedded systems, disadvantages related to using hard disk drives have been found. A hard disk drive consumes a lot of power, entails a large physical size, and is vulnerable to threats such as vibration and humidity, etc.

These problems can be effectively addressed via replacing a hard disk drive with a flash device that consumes little power, involves a small physical size, and is robust and durable compared with a hard disk drive.

However, as flash devices are generally slow in reading and especially in writing compared with hard disk drives, it is infeasible to use flash devices as main storage medium instead of hard disk drives when fast startup is a required. This is especially true for mission-critical applications such as medical and military applications. Although less critical, slow startup makes an appliance less acceptable if an end user has to wait some minutes for the appliance to get ready for operation.

Unfortunately, no such architecture exists for a storage system that is more reliable and boots faster than a hard disk drive. For example, U.S. Pat. No. 5,860,083 fails to disclose a data storage system that boots faster and is robust and durable than a hard disk drive.

### SUMMARY OF INVENTION

It is an objective of the present invention to provide a data storage system that consumes little power.

It is another objective of the present invention to provide a data storage system that is small in size.

It is another objective of the present invention to provide a data storage system that is robust and durable.

It is another objective of the present invention to provide a data storage system that boots fast.

According to the present invention, a computer includes a basic input/output system, an operating system kernel and a data storage system performing as a boot disk for the computer. The data storage system includes a first data storage medium, a second data storage medium, a data storage medium controller and an interface. The first data storage medium is capable of non-volatile storage of data including at least an operating system. The data can be read from and written to the second data storage medium faster than they can be read from and written to the first data storage medium. The data storage medium controller is capable of controlling transfer of the data from the first data storage medium to the second data storage medium when the computer is undergoing initialization. The interface is connected between the data storage medium controller and the computer. Thus, the data can be transferred between the first data storage medium, the second data storage medium and the computer for executing the operating system for booting.

In an aspect, the data storage system may be implemented in a dual-bank memory card including a flash device and a random access memory module including bank #0 and bank #1. The flash device is used as the first data storage medium. Bank #0 of the random access memory is used as the normal system random access memory. Bank #1 of the random access memory is used as the second data storage medium.

In another aspect, the data storage system may be implemented in a dual-bank memory card including bank #0 and bank #1. Bank #0 is a random access memory used as the normal system random access memory. Bank #1 is a very fast flash device used as the first and second data storage medium.

The data storage medium controller is capable of isolating the first data storage medium or the second data storage medium from the computer and emulating the data storage medium that is isolated from the computer.

The emulation is done via wiring chip selection signals of both banks to bank #0 so that the memory card is mistaken by the basic input/output system as including identical random access memories on both bank, thus rendering the memory card fully compatible with existing personal computer systems without the need to modify existing basic input/output systems or operating system kernels.

The emulation is done via modifying the basic input/output system.

The emulation is done via modifying the operating system kernel.

Other objects, advantages and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a block diagram of a data storage system for use in a computer according to the present invention.

FIG. 2 is a block diagram of an IDE disk embodying the data storage system shown in FIG. 1.

FIG. 3 is a block diagram similar to FIG. 2 but showing the IDE disk in a different mode of operation.

FIG. 4 is a block diagram of an IEEE 1394 disk embodying the data storage system shown in FIG. 1.

FIG. 5 is a block diagram similar to FIG. 4 but showing the IEEE 1394 disk in a different mode of operation.

FIG. 6 is a block diagram of an ISA card embodying the data storage system shown in FIG. 1.

FIG. 7 is a block diagram similar to FIG. 6 but showing the ISA card in a different mode of operation.

FIG. 8 is a block diagram of a PCI card embodying the data storage system shown in FIG. 1.

FIG. 9 is a block diagram similar to FIG. 8 but showing the PCI card in a different mode of operation.

FIG. 10 is a block diagram of an SCSI disk embodying the data storage system shown in FIG. 1.

FIG. 11 is a block diagram similar to FIG. 10 but showing the SCSI disk in a different mode of operation.

FIG. 12 is a block diagram of a USB disk embodying the data storage system shown in FIG. 1.

FIG. 13 is a block diagram similar to FIG. 12 but showing the USB disk in a different mode of operation.

FIG. 14 is a flow chart of a process of initialization of a computer equipped with a data storage system as shown in FIGS. 1˜13.

FIG. 15 is a block diagram of a memory card embodying the data storage system shown in FIG. 1.

FIG. 16 is a block diagram similar to FIG. 15 but showing the memory card in a different mode of operation.

FIG. 17 is a block diagram of another memory card embodying the data storage system shown in FIG. 1.

FIG. 18 is a block diagram similar to FIG. 17 but showing the memory card in a different mode of operation.

FIG. 19 is a block diagram of another memory card embodying the data storage system shown in FIG. 1.

FIG. 20 is a block diagram similar to FIG. 19 but showing the memory card in a different mode of operation.

FIG. 21 is a flow chart of a process of initialization of a computer equipped with a data storage system as shown in FIGS. 1 and 14˜20.

### DETAILED DESCRIPTION OF EMBODIMENTS

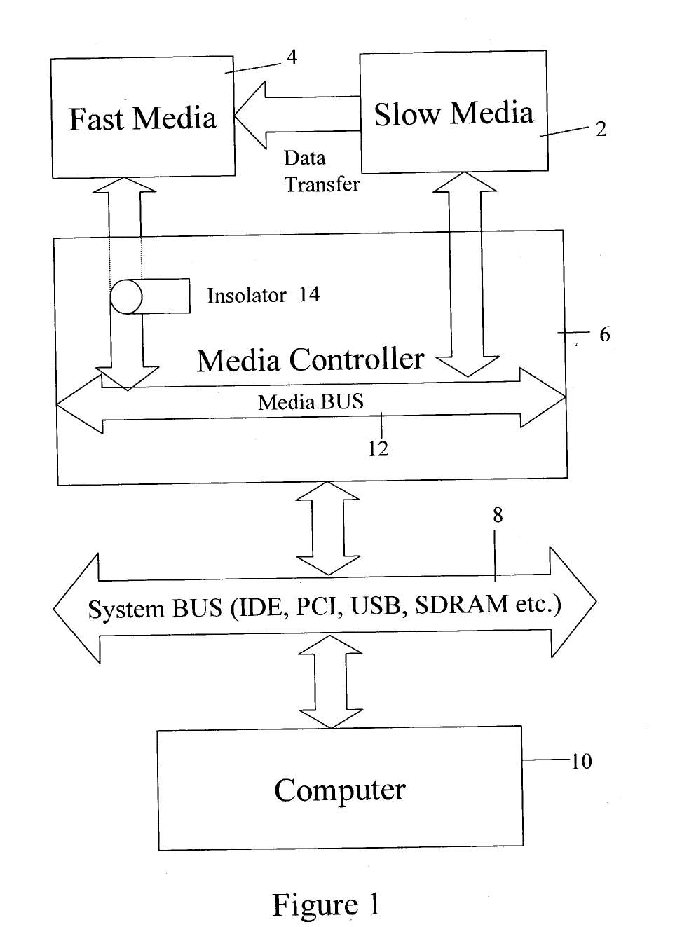

Referring to FIG. 1, according to the present invention, a data storage system for a computer includes a first data storage medium 2, a second data storage medium 4 connected with the fast data storage medium 2, a data storage medium controller 6 connected with the fast data storage medium 2. A system bus 8 is connected between the data storage medium controller 6 and a computer 10. Although not shown, the computer 10 includes a basic input/output system (“BIOS”) for initialization thereof.

The first data storage medium 2 is used to store an operating system and other data in a secure and economic manner whether it is turned on or off. The first data storage medium may be an erasable and programmable non-volatile memory such as a flash device. Compared with a hard disk drive, the first data storage medium 2 consumes less power, involves a small physical size, and is robust and durable.

The second storage 4 is used to receive the operating system from the first data storage medium 2 after the data storage system is turned on. From the second data storage medium 4, the operating system can be read for booting in a time-economic manner. Read/write with the second storage 4 is faster than with a hard disk drive.

The data storage medium controller 6 includes a medium bus 12. The first medium 2 is connected with the medium bus 12. The second medium 4 is connected with the medium bus 12. The data storage medium controller 6 includes an isolator 14 connected between the medium bus 12 and the second medium 4. The data storage medium controller 6 is used to control the operation of the whole data storage system.

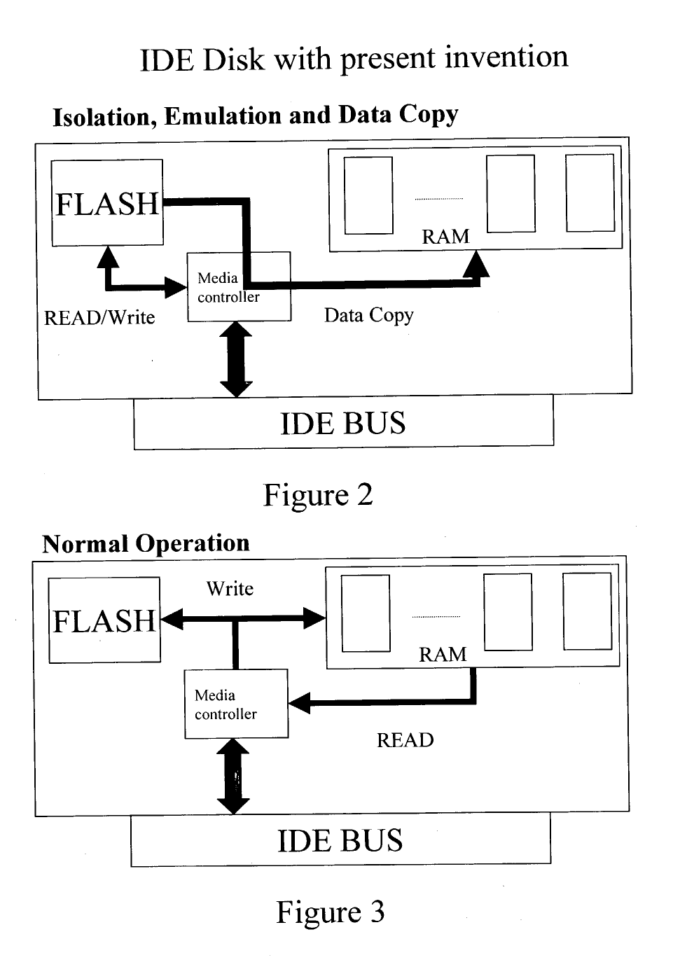

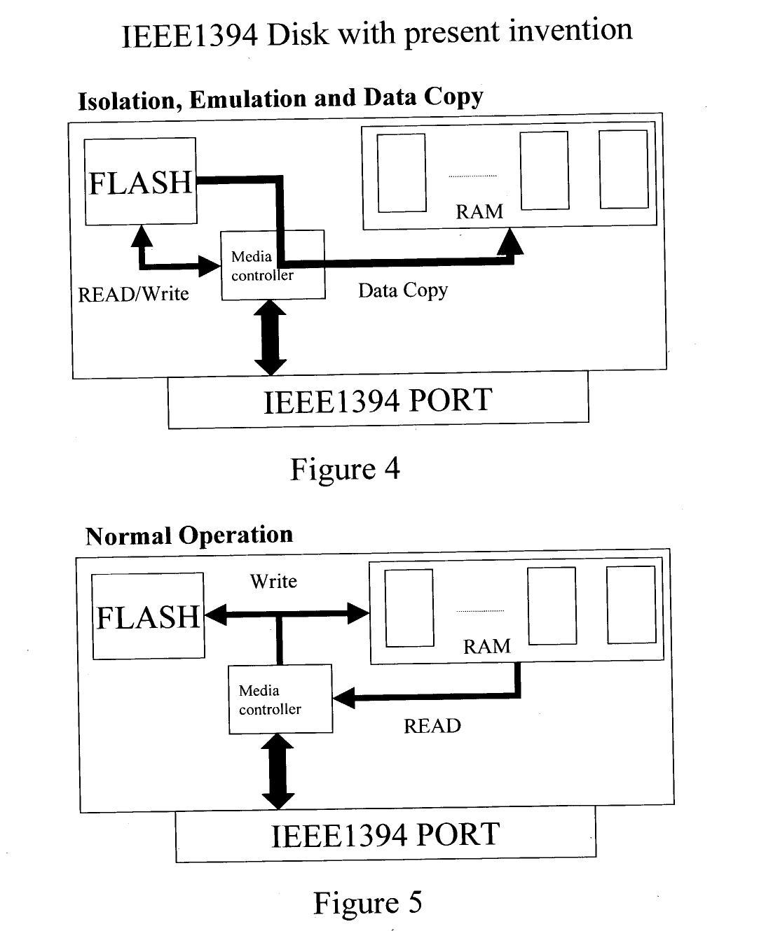

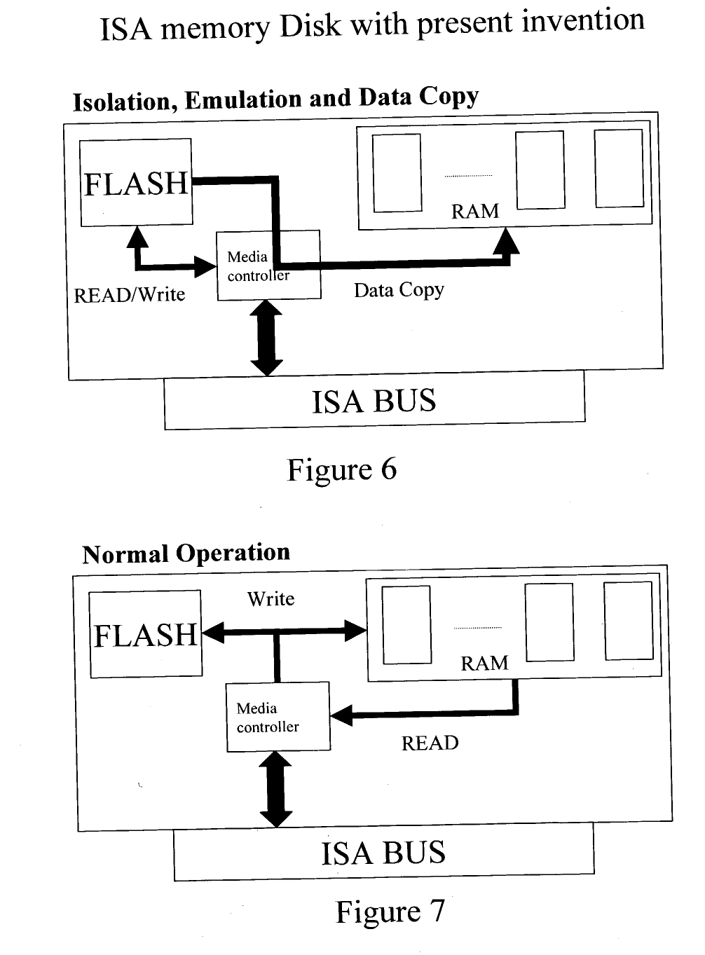

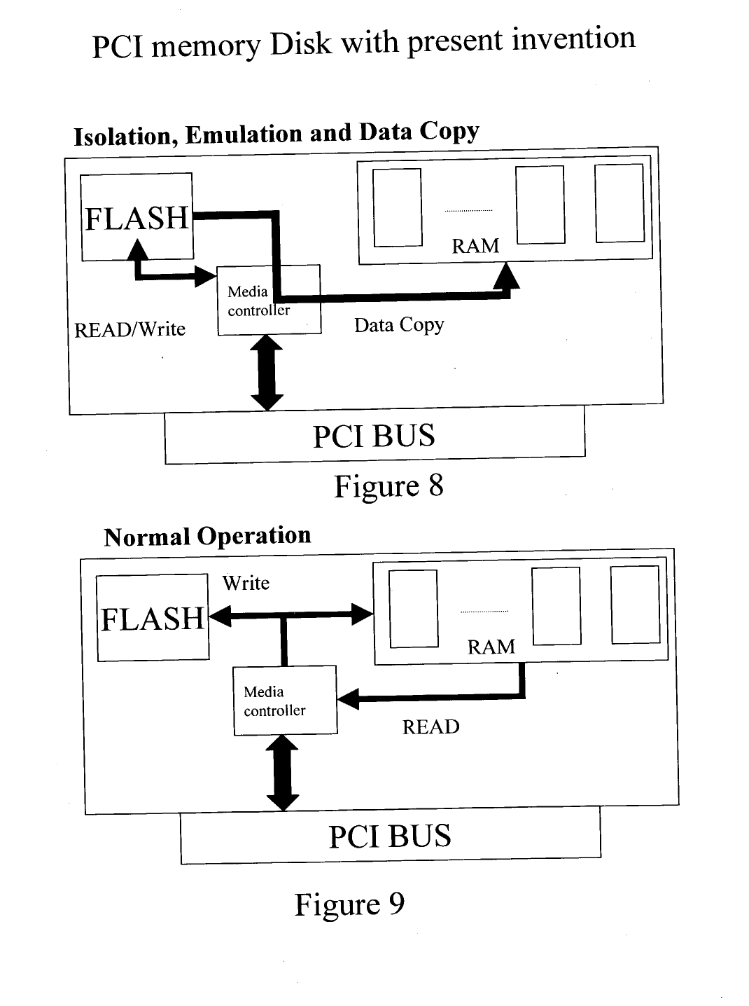

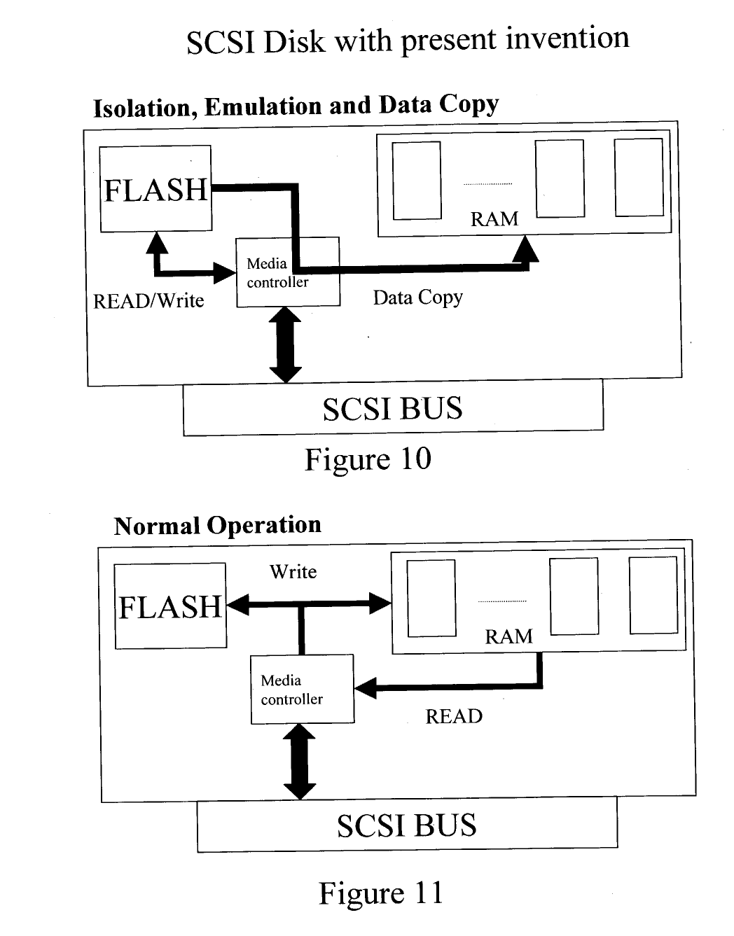

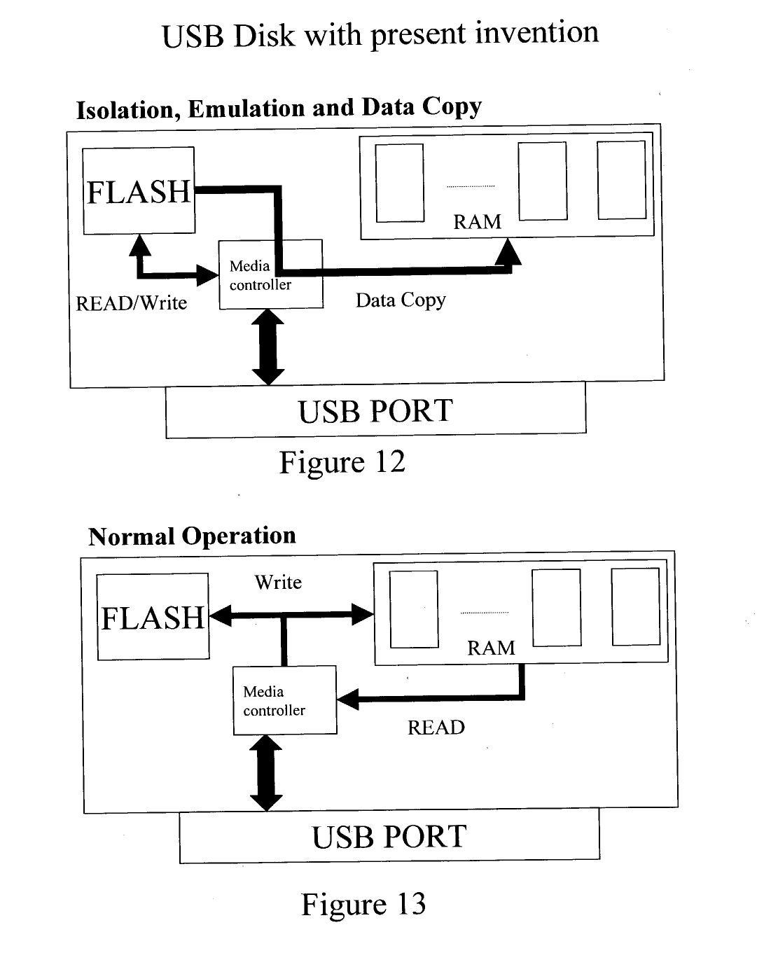

Referring to FIGS. 2˜13, the first data storage medium 2 is a flash device, and the second data storage medium 4 is a random access memory (“RAM”) module. The system bus 8 may be an IDE bus as shown in FIGS. 2 and 3, an IEEE 1394 bus as shown in FIGS. 4 and 5, an ISA bus as shown in FIGS. 6 and 7, a PCI bus as shown in FIGS. 8 and 9, an SCSI bus as shown in FIGS. 10 and 11 or a USB bus as shown in FIGS. 12 and 13.

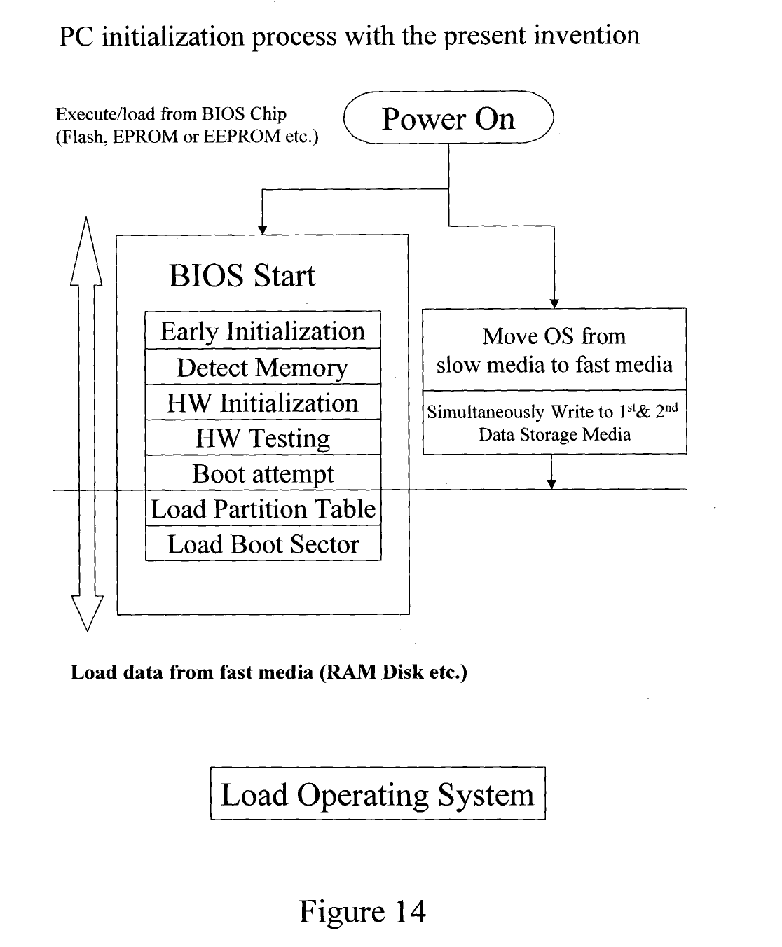

Referring to FIG. 14, when the computer 10 including the BIOS and the data storage system according to the present invention is turned on, the BIOS proceeds with the process of initialization thereof, and the data storage medium controller 6 proceeds with some tasks to be described.

While the BIOS performs early initialization, memory detection and hardware initialization, the data storage medium controller 6 transfers the operating system from the first data storage medium 2 to the second data storage medium 4. When the BIOS is ready for an attempt to boot the computer 10, the transfer of the operating system from the first data storage medium 2 to the second data storage medium 4 has been finished. Thus, the operating system can be read from the second data storage medium 4 for booting in a time-economic manner.

After the BIOS boots the computer 10 successfully, to ensure data integrity, wherever a “WRITE” request is sent from the computer 10 to the data storage medium controller 6,on receiving the “WRITE” request, the data storage medium controller 6 writes identical data to the first data storage medium 2 (a flash device) and the second data storage medium (RAM) simultaneously.

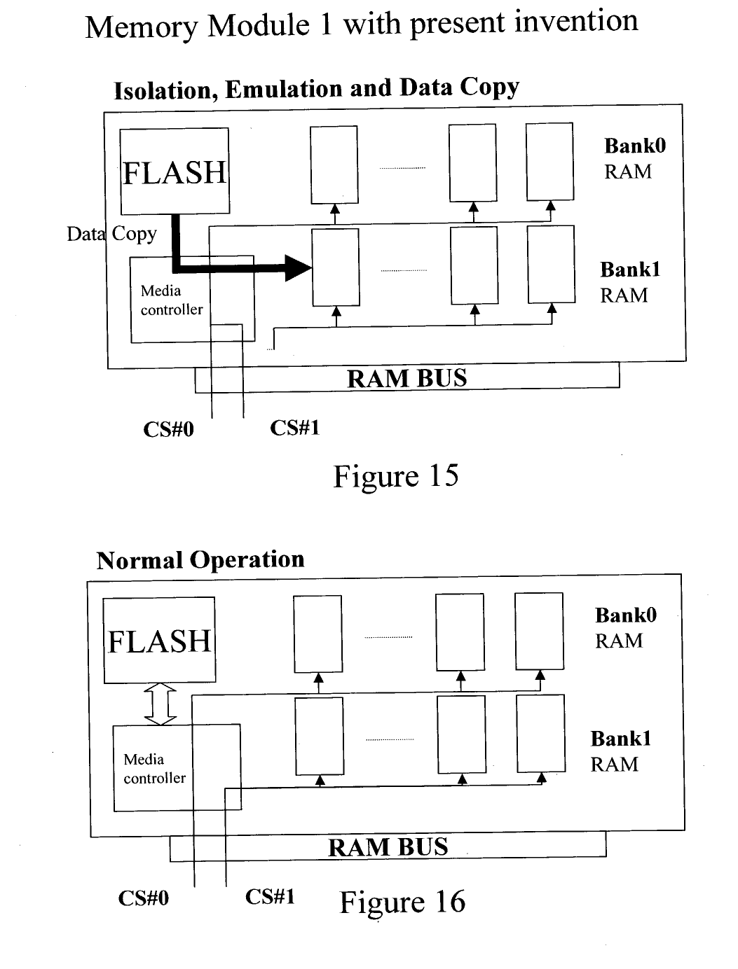

FIGS. 15 and 16 are similar block diagrams of a memory card embodying the data storage system shown in FIG. 1. This memory card includes a data storage medium controller 6, a flash device, bank #0 and bank #1. Bank #0 is a bank of RAM. Bank #1 is also a bank of RAM. The flash device is used as the first data storage medium 2. Bank #0 is used as the normal system RAM. Bank #1 is used as the second data storage medium 4. The system bus 8 is a RAM bus.

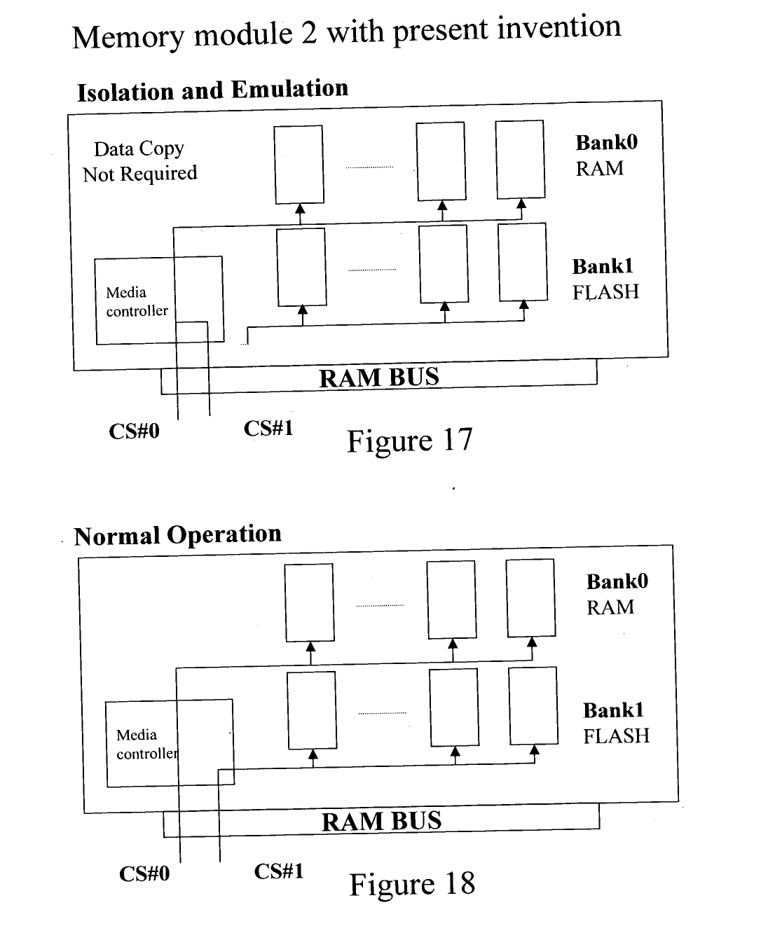

FIGS. 17 and 18 are similar block diagrams of another memory card embodying the data storage system shown in FIG. 1. This memory card includes a data storage medium controller 6, bank #0 and bank #1. Bank #0 is a bank of RAM. Bank #1 is a bank of fast flash devices directly accessible through RAM Bus. Bank #0 is used as the normal system RAM. Bank #1 is used as both the first data storage medium 2 and the second data storage medium 4. In other words, the first data storage medium 2 and the second data storage medium 4 are merged in bank #1. In other words, the second data storage medium 4 is eliminated. Because the first data storage 2 is sufficiently fast as consisting of RAM, an additional data storage medium for fast boot the computer is no longer necessary. In this case, no transfer of data occurs between the first data storage medium 2 and the second data storage medium 4. The system bus 8 is a RAM bus.

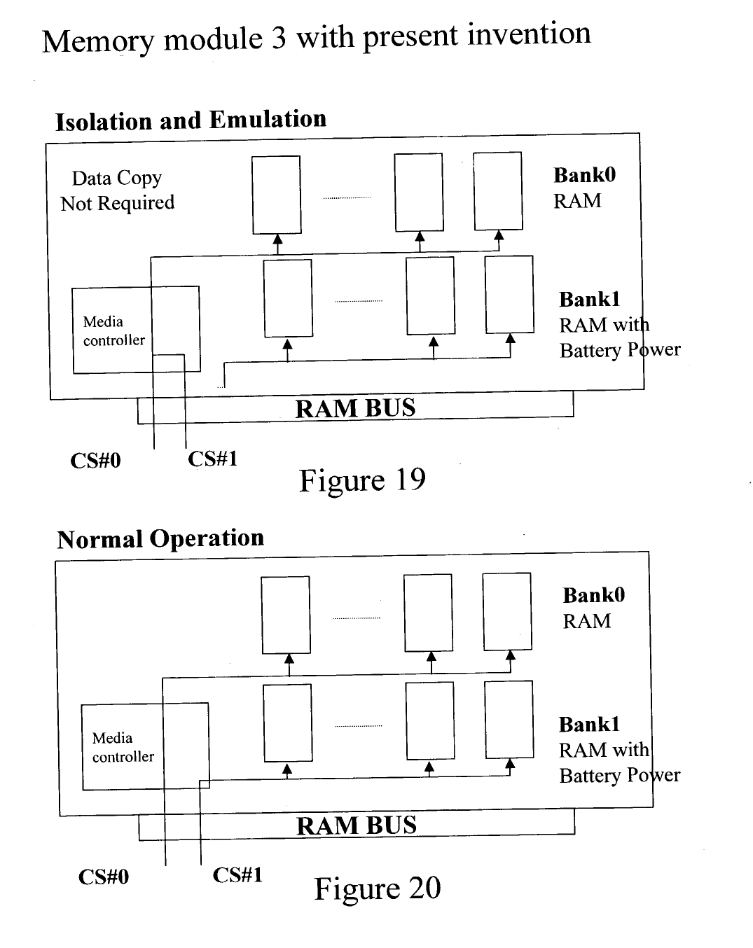

FIGS. 19 and 20 are similar block diagrams of another memory card embodying the data storage system shown in FIG. 1. This memory card includes a data storage medium controller 6, bank #0 and bank #1. Bank #0 is a bank of RAM. Bank #1 is a bank of RAM connected with and powered by means of a power supply such as a battery (not shown). Bank #0 is used as the normal system RAM. Bank #1 is used as both the first data storage medium 2 and the second data storage medium 4. In other words, the first data storage medium 2 and the second data storage medium 4 are merged in bank #1. In other words, the second data storage medium 4 is eliminated. Because the first data storage 2 is sufficiently fast as consisting of RAM, an additional data storage medium for fast boot the computer is no longer necessary. In this case, no transfer of data occurs between the first data storage medium 2 and the second data storage medium 4. The system bus 8 is a RAM bus.

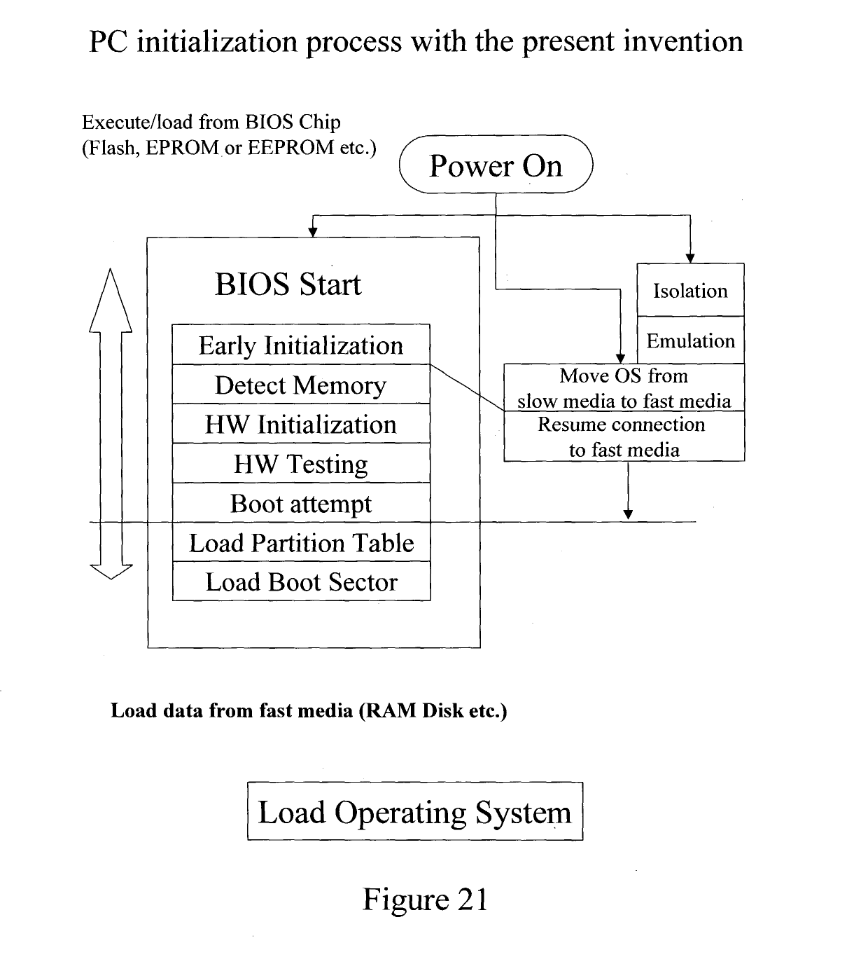

Referring to FIG. 21, when the computer 10 including the BIOS and the data storage system according to the present invention is turned on, the BIOS proceeds with the process of initialization thereof, and the data storage medium controller 6 proceeds with some tasks to be described.

When the data storage system receives power and starts up, the data storage medium controller 6 instructs the isolator 12 to isolate the second data storage medium 4 from the system bus 8 to avoid the data stored in the second data storage medium data 4 being destroyed by the process of the initialization of the computer 10. Before the BIOS starts any process such as “Memory Detection” that includes writing data to the second data storage medium 4, the data storage medium controller 6 must command the isolator 12 to isolate the second data storage medium 4 from the system bus 8. Thus, the data stored in the second data storage medium 4 will not be interrupted and destroyed due to the BIOS writing data to the RAM module 4.

When the second data storage medium 4 is isolated from the system bus 8 during the process of the initialization of the computer 10, the computer 10 cannot recognize it and therefore assumes that the second data storage medium 4 does not exist. The second data storage medium 4 will not function even if it is later connected with the system bus 8. Therefore, it is necessary for the data storage medium controller 6 to emulate the existence of the second data storage medium 4 to make sure that the second data storage medium can be utilized by the computer 10. Referring to FIG. 15, memory cards emulate the existence of the second data storage medium 4, i.e., bank #1 via coupling the chip select signals to “cheat” the BIOS so that the BIOS believes the memory module consists of two identical banks.

As the second data storage medium 4 is isolated from the RAM bus 8, the data storage medium controller 6 transfers data from the flash device to bank #1 when the memory cards receive power and start up.

Right before an attempt to boot the computer 10 by means of the BIOS, the data storage medium controller 6 starts to take commands from the computer 10 and process the commands. When the data storage medium controller 6 finishes with data transfer, it waits for the computer 10 to give commands to turn off isolation and emulation to allow access to bank #1 with useful data by the computer 10 in order to continue the process of booting.

According to the present invention, the data storage medium controller 6 provides a data transfer function to transfer data between the first data storage medium 2 and the second data storage medium 4. The data transfer function of the storage data storage medium controller 6 is implemented to be transparent to the system bus 8. Hence, no modification of the existing computer 10 is required. When the computer 10 starts, the operating system is transferred from first data storage medium 2 to the second data storage medium 4 in parallel to the initialization of the computer 10. When reaching the last stage of the initialization, the computer 10 boots from the second data storage medium 4, thus shortening the time required for the initialization of the computer 10.

The computer 10 may be, but is not limited to, a personal computer (“PC”) running DOS, any operating system provided by Microsoft, OS/2™ or Linux, or a Macintosh computer, or a computer running JAVA™ OS as the operating system, or a graphical workstation such as computers provide by Sun Microsystems and Silicon Graphics, or any other computer including a version of the UNIX operating system such as AIX™ or SOLARIS™ provided by Sun Microsystems or any other known and available operating system, including operating systems such as Windows CE™ for embedded systems, including cellular telephones, handheld computational devices and palmtop computational devices, and any other computational device which can be connected to a network. Hereinafter, the operating systems provided by Microsoft include but is not limited to Windows 95™, Windows 3.X™ (in which “X” is an integer such as “1”), Windows NT™, Windows 98™, Windows CE™ and any upgraded versions of these operating systems.

The present invention has been described via illustration of some embodiments. The applicant gives these embodiments only as examples, and those skilled in the art can derive variations from the embodiments after a study of this specification. Therefore, these embodiments shall not limit the scope of the present invention that is defined in the following claims.

What is claimed is:

1. A data storage system performing as a boot disk for a computer, the data storage system including:
a first data storage medium for non-volatile storage of data including at least an operating system;
a second data storage medium, wherein the data can be read from and written to the second data storage medium faster than they can be read from and written to the first data storage medium;
a data storage medium controller for controlling transfer of the data from the first data storage medium to the second data storage medium when the computer is undergoing initialization; and
an interface connected between the data storage medium controller and the computer so that the data can be transferred between the first data storage medium, the second data storage medium and the computer for executing the operating system for booting.

2. The data storage system of claim 1 including a dual-bank memory card including bank #0 used as a normal system memory and bank #1 on which the second data storage medium is installed.

3. The data storage system of claim 2 wherein the first data storage medium is a flash device, and the second data storage medium is a random access memory installed on bank #1 of the dual-bank memory card.

4. The data storage system of claim 2 wherein the first data storage medium is a flash device accessible directly through random access memory bus installed on bank #1 of the dual-bank memory card, and the second data storage medium is identical to the first data storage medium.

5. The data storage system of claim 2 wherein the first data storage medium is a random access memory powered by means of a battery installed on bank #1 of the dual-bank memory card, and the second data storage medium is identical to the first data storage medium.

6. The data storage system of claim 2 wherein the data storage medium controller is capable of isolating at least one of the first data storage medium and the second data storage medium from the computer and emulating the data storage medium that is isolated from the computer.

7. The data storage system of claim 6 wherein the emulation is done via wiring chip select signals of bank #0 and bank #1 to bank #0.

8. The data storage system of claim 1 wherein the interface is an IDE bus.

9. The data storage system of claim 1 wherein the interface is an IEEE 1394 port.

10. The data storage system of claim 1 wherein the interface is an ISA bus.

11. The data storage system of claim 1 wherein the interface is a PCI bus.

12. The data storage system of claim 1 wherein the interface is an SCSI bus.

13. The data storage system of claim 1 wherein the interface is a USB bus.

14. A computer including a basic input/output system, an operating system kernel and a data storage system performing as a boot disk for the computer, the data storage system including:
a first data storage medium for non-volatile storage of data including at least an operating system;
a second data storage medium, wherein the data can be read from and written to the second data storage medium faster than they can be read from and written to the first data storage medium;
a data storage medium controller for controlling transfer of the data from the first data storage medium to the second data storage medium when the computer is undergoing initialization; and
an interface connected between the data storage medium controller and the computer so that the data can be transferred between the first data storage medium, the second data storage medium and the computer for executing the operating system for booting.

15. The data storage system of claim 14 including a dual-bank memory card including bank #0 used as a normal system memory and bank #1 on which the second data storage medium is installed.

16. The data storage system of claim 15 wherein the first data storage medium is a flash device, and the second data storage medium is a random access memory installed on bank #1 of the dual-bank memory card.

17. The data storage system of claim 15 wherein the first data storage medium is a flash device accessible directly through random access memory bus installed on bank #1 of the dual-bank memory card, and the second data storage medium is identical to the first data storage medium.

18. The data storage system of claim 15 wherein the first data storage medium is a random access memory powered by means of a battery installed on bank #1 of the dual-bank memory card, and the second data storage medium is identical to the first data storage medium.

19. The computer of claim 15 wherein the data storage medium controller is capable of isolating at least one of the first data storage medium and the second data storage medium from the computer and emulating the data storage medium that is isolated from the computer.

20. The computer of claim 19 wherein the emulation is done via wiring chip selection signals of the banks to bank #0.

21. The computer of claim 19 wherein the emulation is done via modifying the basic input/output system.

22. The computer of claim 19 wherein the emulation is done via modifying the operating system kernel.
